(19) United States
(12) Patent Application Publication
(10) Pub. No.: US 2013/0332379 A1
(43) Pub. Date: Dec. 12, 2013

(54) Method and Apparatus for Mobile Video Sharing

(71) Applicant: Flikkety Flik Inc., Chicago, IL (US)

(72) Inventors: Tracy Hayes, Downers Grove, IL (US); Christopher Hayes, Downers Grove, IL (US)

(21) Appl. No.: 13/915,185

(22) Filed: Jun. 11, 2013

Related U.S. Application Data
(60) Provisional application No. 61/658,529, filed on Jun. 12, 2012.

(51) Int. Cl. G06Q 50/00; G06Q 30/02

(52) U.S. Cl. CPC G06Q 50/01; G06Q 30/0282
USPC 705/319

(57) ABSTRACT

A system allows for disseminating information about a user's experience with an entity. The system has processor for communication with a plurality of computers in a network. The system processor is configured to: (i) store in a memory a data structure comprising data items representative of a profile of the user, a profile of the entity and a video representative of the experience of the user with the entity; (ii) receive video data from at least one of the plurality of remote computers; (iii) associate the video data with the profile of the user and the profile of the entity to generate the data structure; and (iv) provide experience data to remote computers in accordance with criteria associated with the user profile and the entity profile wherein the provided data pertains to the user profile, the entity profile, and the video data.

### RELATED APPLICATION DATA

This application claims the benefit of provisional application Ser. No. 61/658,529, filed Jun. 12, 2012, the disclosure of which is incorporated by reference herein.

### BACKGROUND AND SUMMARY

This disclosure relates generally to wireless communication networks and, more particularly, to a method and apparatus for providing a mobile social media platform where mobile users share their commercial experiences through limited audio/video presentations to a web community.

As will be described below in greater detail, a system and method are provided to allow mobile device users (“subscribers”) to post audio/video presentations regarding commercial experiences (i.e., “fliks”) with the convenience of their mobile devices. Preferably, the flik has a limited time length. For instance, the time length may be 7 seconds or less, or may be in a range of time of 6 seconds to 15 seconds. The system may further have programming configured to enable a subscriber to create a “landing” or “home page” where the subscriber's fliks may be posted. The system may further have programming configured to enable a commercial entity (“business subscriber”) to create a “landing” or a “home page” where subscriber generated fliks relevant to the business subscriber may be posted. The system may further have programming configured to determine a subscriber's geographic location to increase the utility of the system. The system may have programming configured to analyze fliks generated by subscribers and provide analytics and metrics to business subscribers, for instance, metrics on subscriber behavior, usage, and statistics. In turn, the system may have programming configured to provide aggregated data to businesses to enable businesses to provide incentives to mobile users of the system to generate further fliks. Business may also use the information for marketing and promotional activities. For instance subscriber user profile data (e.g., wireless users' usage patterns, preferences and the like) from use of the system can be leveraged to support marketing initiatives such as advertisement (ad) insertions.

As disclosed below, the system and methods involve a communication network with a plurality of subscribers utilizing mobile devices and a plurality of business subscribers interconnected on the system through the network. Subscribers may generate fliks from their respective mobile devices through a mobile service portal (i.e., mobile application) downloaded to the mobile device. The mobile application may provide a viewing function and editing function. The viewing function affords viewing of the flik and is provided in accordance with a user profile of the viewer, for instance, a viewing preference of the subscriber. The system may further have programming configured to enable subscribers to generate fliks via a mobile device and upload the fliks via a mobile application to an internet platform. The system may be configured with programming to generate data with the upload of the flik. The data may be representative of a location, business, or other criteria as selected by a business subscriber or an individual subscriber.

In one embodiment, the mobile application may have programming to support video editing. In one embodiment, the mobile application may include a subscriber login portal, with templates that a subscriber may select to create the subscriber's landing or home page. The subscriber login portal may also include programming for video editing capabilities, category and key words assignment, and post-to-system server functionality. In one embodiment, the system may have programming to allow a subscriber user to opt in for ad insertion capabilities and revenue sharing opportunities. In one embodiment, the system may have programming configured to allow other subscribers to comment on a flik, reply to a flik, rate a flik, view fliks by groups and categories, view fliks by the most viewed, view fliks by the highest rating, etc.

Additional advantages of the system and methods, as well as variations, will be seen in the description that follows.

### BRIEF DESCRIPTION OF THE DRAWINGS

FIG. 1 illustrates an environment adapted to support mobile communications devices in accordance with embodiments described below.

FIG. 2(a) is a high level block diagram illustrating a functional view of a typical mobile communications device in accordance with some embodiments described below.

FIG. 2(b) is a high level block diagram illustrating a functional view of a mobile application provided on the mobile communications device of FIG. 2(a) in accordance with some embodiments described below.

FIGS. 3 and 4 are flowcharts illustrating the overall process by which a subscriber interacts with the system generating a flik to be posted via the system and conducting related activities via the system.

FIG. 5 is a flowchart showing the process by which a subscriber sets parameters for generating a flik before uploading the flik the system.

FIG. 6 is a flowchart illustrating the various methods by which a subscriber user may upload a flik to the system.

FIG. 7 is a flowchart illustrating the process by which a subscriber may upload a flik via a cellular telephone type network.

FIG. 8 is a flowchart illustrating the process by which a subscriber may upload a flik to the system via a business subscriber's flik configured WiFi service.

FIG. 9 is a flowchart illustrating functionality associated with a flik stand or kiosk and the activities a subscriber may perform at a flik stand or kiosk.

FIG. 10 is a flowchart illustrating a process by which a subscriber may generate a request to which other subscribers may respond.

FIG. 11 is a flowchart illustrating the process by which a subscriber may select time and identification options before posting a flik to the system.

FIG. 12 is a flowchart illustrating a process by which a subscriber may perform searches of flik related information via system.

FIG. 13 is a flowchart illustrating a process by which a subscriber may perform a search via the system based upon selected groups of subscribers or a selected individual subscriber.

FIG. 14 is a flow chart illustrating a process by which a user may search for other subscriber users on the system and receive information regarding products and services purchased by other subscribers on the system.

FIG. 15 is a flow chart illustrating a process of by which a user may associate a web address with a flik.

FIG. 16 is a flow chart illustrating a process utilized by the system for processing video images to provide uniformity for user generated fliks.

FIG. 17 is a flow diagram illustrating a process whereby a user may combine two videos into a composed flik.

FIG. 18 is a flow diagram illustrating a process whereby the system analyzes video generated by many users of the system based upon timestamp and geographic location information and provides options for display to users of the system.

### DETAILED DESCRIPTION

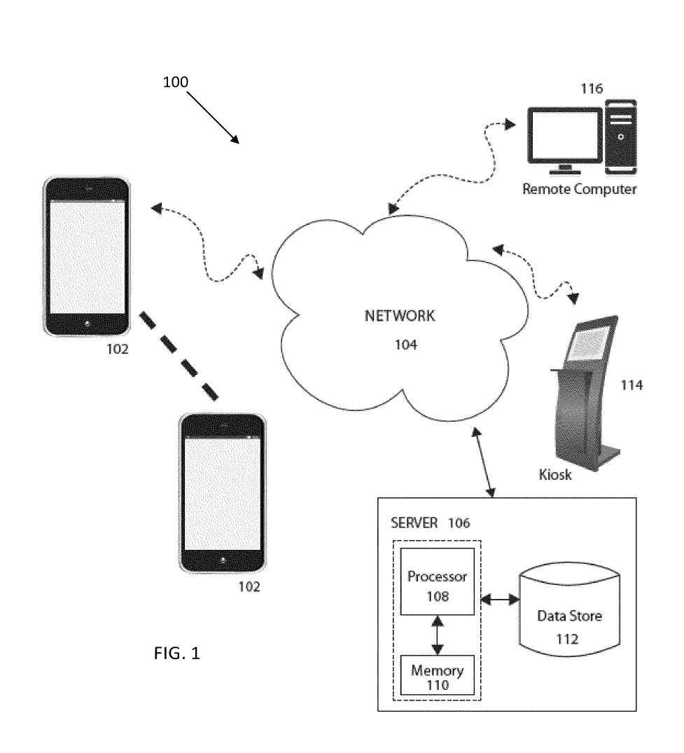

FIG. 1 illustrates an exemplary communication network 100 for supporting the subscriber, business subscriber, and the system interfaces. The subscriber's mobile devices are indicated by reference character 102. As shown in FIG. 1, the mobile device may communicate between each other using conventional cellular communications, short messaging services, and/or other conventional web-based systems. The mobile devices 102 may be a smart phone (e.g., an iPhone, a Google Android device, a Blackberry device, etc.), a tablet computer (e.g., an iPad), or the like. Each of the subscriber mobile devices may communicate via network indicated by reference character 104, and may comprise the internet network, and/or an enterprise network, local area network or other network. As illustrated in FIG. 1, the system comprises a server 106 comprising a processor 108 having access to a memory 110 and a database 112. The server 106 is in communication with the network 104, and the processor 108 is in communication with the memory 110 and database 112. Also connected to the network is a kiosk 114. The kiosk may comprise a remote computer capable of connecting to the internet or other data communications network, and optionally includes a conventional web browser program (Internet Explorer) to enable communications with the server 106. Also included in the system is a remote computer 116. The remote computer can be a standard personal computer (PC) or laptop capable of connecting to the internet, or other data communications network, and optionally including a conventional web browser program (such as Internet Explorer).

The processor 108 may be resident on the server 106 where the server 106 is configured to communicate with the mobile device 102, the remote computer 116, or the kiosk 114 via the network 104. The server may be configured to host a website through which the mobile device 102, kiosk 114, or remote computer 106 access the functionality described herein. It should be understood that the server 106 may be configured to host mobile application sites to which the mobile devices 102 can access the functionality described herein. Further, it should be understood that the processor 108 may comprise multiple processors for performing the functionality described herein in a distributed manner, and that the servers may comprise multiple servers. Programming may include programming on one or multiple processors for performing the functionality described herein in a distributed manner.

The memory 110 and database 112 may be resident on any one or more physical memories that can take the form of a non-transitory computer-readable storage medium. Such memory can be configured to store data structures representative of the profiles described herein as well as data structures representative of the programming instructions described herein. For example, the memory 110 may take the form of RAM within the server and the memory for the database 112 may take the form of a hard drive or the like within the server or accessible by the server. Further still, it should be understood that the database 112 may be optionally distributed across multiple physical memories as a plurality of databases.

It should be noted that the system described herein may be implemented in software and/or in a combination of software and hardware, e.g., using application specific integrated circuits (ASIC), a general purpose computer or any other hardware equivalents. Programming for the system and/or mobile device may be loaded into memory and executed by processor to implement the functions discussed herein. As such, programming may be stored on a computer readable medium, e.g., RAM memory, magnetic or optical drive or diskette and the like.

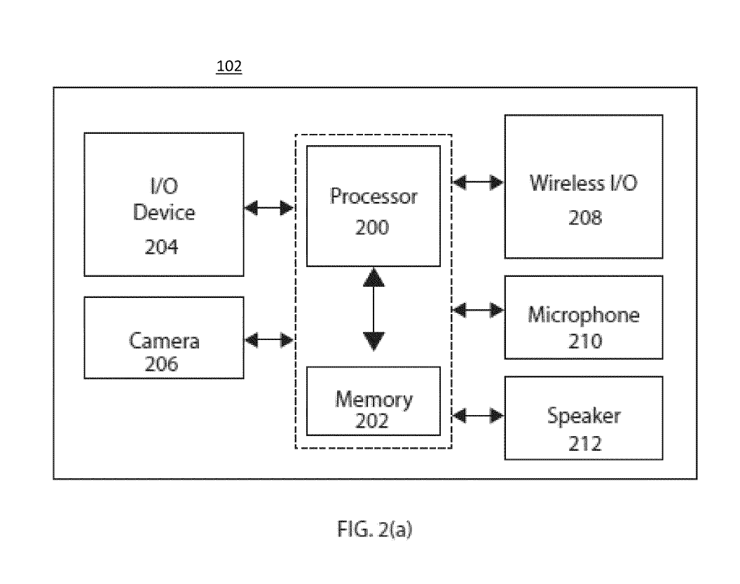

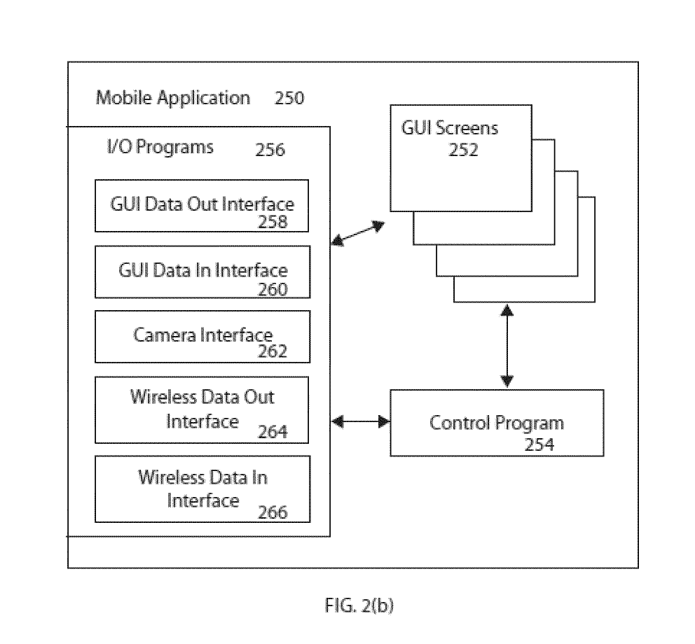

FIG. 2(a) is a high level block diagram illustrating a functional view of a typical mobile communications device 102. Illustrated are at least one processor 200 coupled to memory 202. The processor is coupled to an input/output device 204, a camera 206, a wireless input/output port 208, a microphone 210, and a speaker 212. The memory 202 stores instructions and data used by the processor 200. As is known in the art, the mobile communications device 102 is adapted to execute computer programs for performing the functionality described herein. As used herein, the term “program” or “programming” refers to computer program logic utilized to provide the specified functionality. Thus, a program or programming may be implemented in hardware, firmware and/or software. A program or programming may be stored on the memory 202 of the device 102 and executed by the processor 200. A program or programming may be loaded as part of client applications downloaded via the system.

FIG. 2(b) shows a high level block diagram illustrating the functionality of the mobile application containing the functionality described herein. The processor 200 may be configured to execute instructions stored in memory 202 to generate the mobile application 250 shown in FIG. 2(b). The program may include instructions to enable the presentation of several graphic user interfaces 252. The mobile application may further include a control program 254 to allow presentation of the graphic user interfaces to the subscriber via the mobile device. The control program 254 may enable the subscriber to access several input/output programs 256 associated with the functional modules 204,206,208,210,212 shown in FIG. 2(a). The programs may include a graphic user interface 258 to enable the subscriber to provide data associated with a flik before the flik is uploaded to the system. Programming may be configured to present a display 260 that enables the subscriber to receive data from the network. Programming may be configured to present a display 262 to enable the subscriber to utilize a camera 206. Programming may be configured to present displays 264,266 to enable the subscriber to receive and transmit data wirelessly through wireless input/output devices 208.

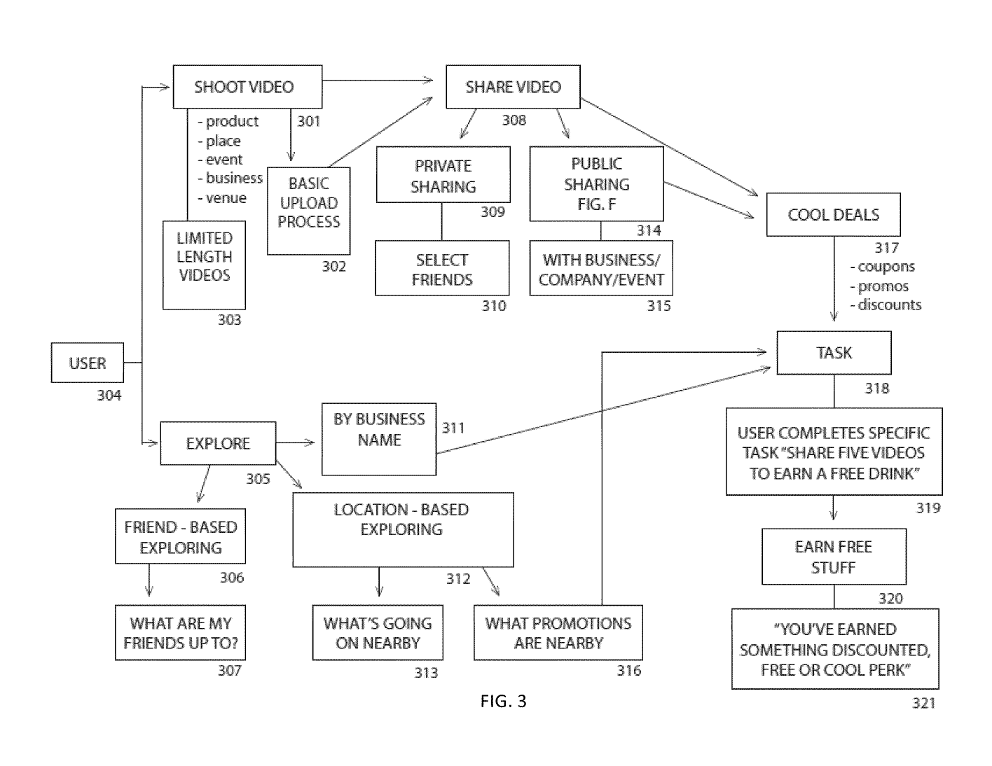

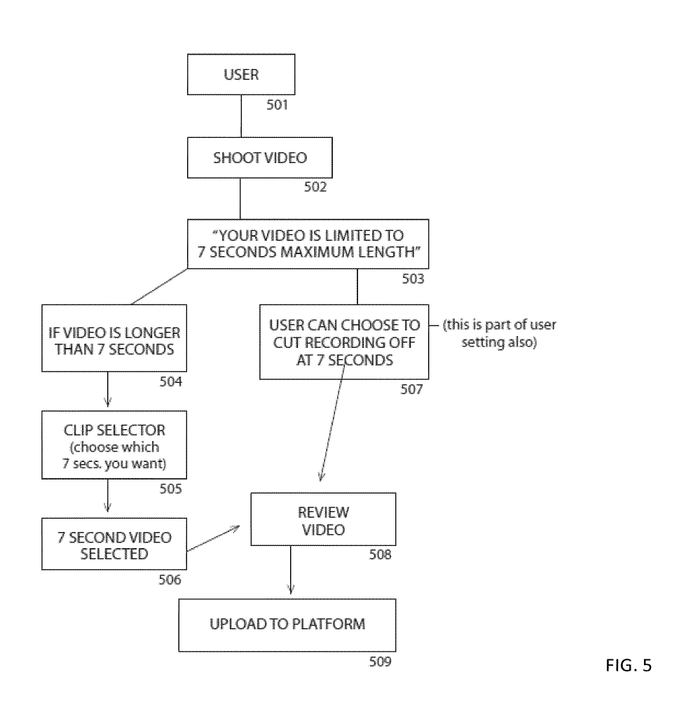

FIG. 3 shows a high level flow chart illustrating the process by which a subscriber may interact with the system. As shown in FIG. 3, a user 304 may generate a flik (301). The flik is preferably limited in length (303). The length of the flik may be seven seconds. The length may also be in a range of six seconds to fifteen seconds depending upon the application and the user. A further discussion of this functionality follows below in reference to the discussion of FIG. 5.

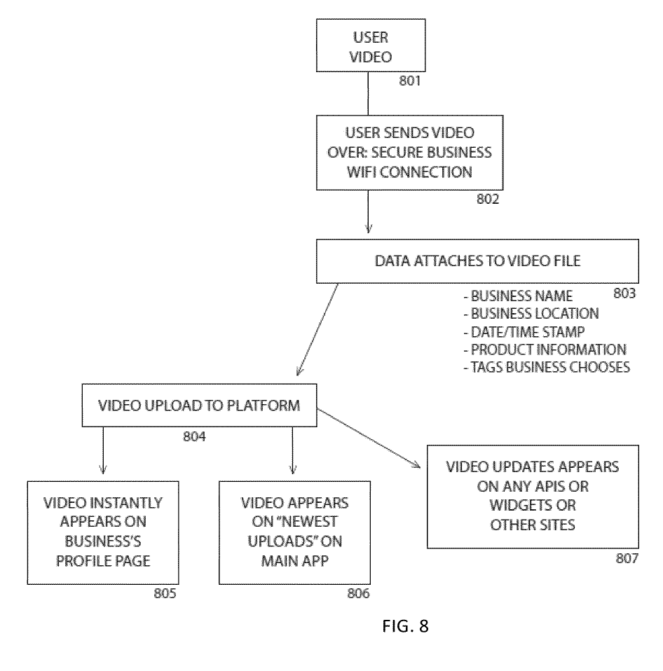

During generation of the flik, the subscriber may provide or the system may generate data regarding the product, place, event, business or venue. This data will be provided through the graphic interface previously discussed generated by the mobile application on the mobile device 102. Data structures associated with the input from the subscriber mobile device user may include commercial data. The commercial data may include the business name, business location, business contact information, business hours, business website, business genre, product name, business rating, product rating, and a number of individuals or subscribers favorably associated with the business. A further data structure may include subscriber data. The subscriber data may include the subscriber's name, and the identity of persons or other subscribers currently accompanying the subscriber while generating the flik. Another, the data structure may include data about the video. For instance, the video data may include a time stamp, a location where the video was taken, information about whether a subscriber liked or disliked the video. The video data may further include data to enable the execution of instructions to post the video either at the subscriber's personal home page or a business subscriber's home page, or whether to distribute the video generally through the web to other mobile device users or other subscribers. The video data structure may further include data enable the execution of instructions enabling others to comment on the video or to tabulate the total number of people who have viewed the flik. The programming and database structure may enable a subscriber to provide information stored in the database with a flik. For instance, the user may create customized tags or folders to store generated fliks. A further discussion of this functionality follows below in reference to the discussion of FIG. 8.

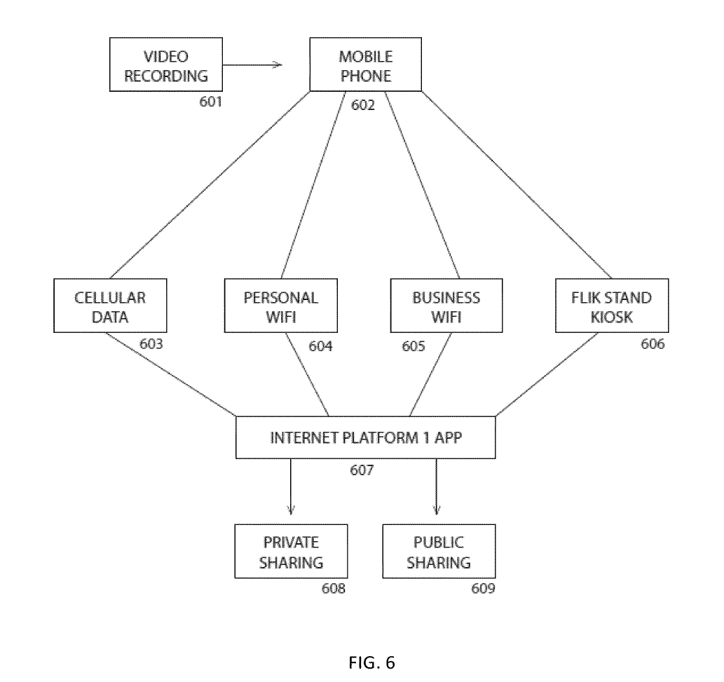

Once the video is uploaded (302), the mobile application and/or system may have programming configured to share the video (308). As described previously, the mobile application and/or system may be configured with programming to enable the video to be shared through the system to a selected group of subscribers (i.e., “private sharing” (309)). The mobile application and/or system may be further configured to enable a subscriber to select a group of subscriber users (i.e., “friends” (310)). Alternatively, or in addition to, the mobile application and/or system may be configured to enable the subscriber to publicly share the flik (314). The mobile application and/or system may be further configured to enable the subscriber to post the video to a business subscriber's home page (315). A further discussion of this functionality follows below in reference to the discussion of FIG. 6.

In addition, a subscriber may have the ability to categorize and/or sort a generated flick as publicly shared or privately shared. For instance, the system and/or mobile application may have programming configured to enable the subscriber to create a hierarchical display on the viewer or display of the subscriber's mobile device where publicly shared fliks are displayed in one area of the viewer and privately shared fliks are displayed in a separate area of the viewer. As a further example, programming may be configured to present the display of a thumbnail image of a generated flik. The programming may also be configured to allow the subscriber to direct the thumbnail image of the flik to a respective area of the viewer depending upon whether the flik is a publicly or privately shared. In addition to, or in the alternative, a title of the flik may appear in the respective area of the viewer, and the programming may be configured to allow the subscriber to direct the display of the title of the flik to a respective area of the viewer depending upon whether the flik is a publicly or privately shared. As a further example, the system and/or mobile application may have programming configured to allow the user to select and drag the thumbnail image or the display of the title of the flik to the respective area of the viewer. For instance, after the flik is generated, a thumbnail image of the flik may appear in the touch screen graphic user interface display of the subscriber's mobile device, and the programming may be configured to allow the subscriber to select and drag the thumbnail image in a certain direction to categorize the flik as a publicly or privately shared flik, and to allow the subscriber to sort a flik as a publicly or privately shared flik.

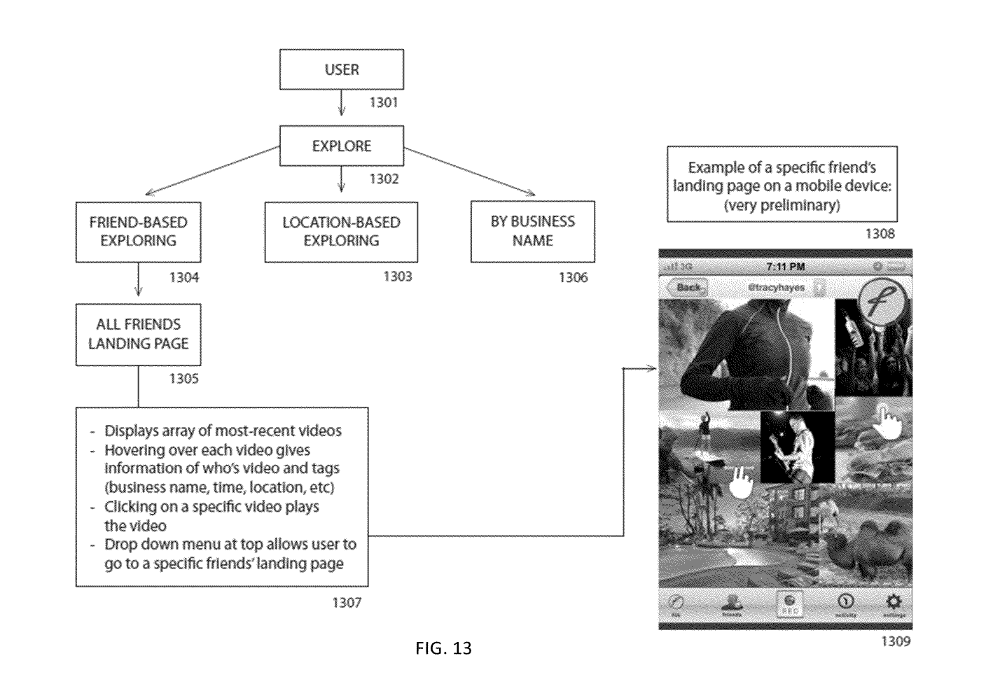

Also, as shown in FIG. 3, the mobile application and/or system may be configured to enable the user to search for businesses in the subscriber's proximate geographic location. The mobile application and/or system may have programming configured to enable the subscriber to search for other subscribers (306). For instance, the mobile application and/or system may also have programming configured to enable the subscriber to create a grouping of other subscribers (i.e., “friends”), and the programming may be configured to enable the subscriber to locate “friends” and to view fliks generated by “friends” (306, 307). A further discussion of this functionality follows below in reference to the discussion of FIG. 13.

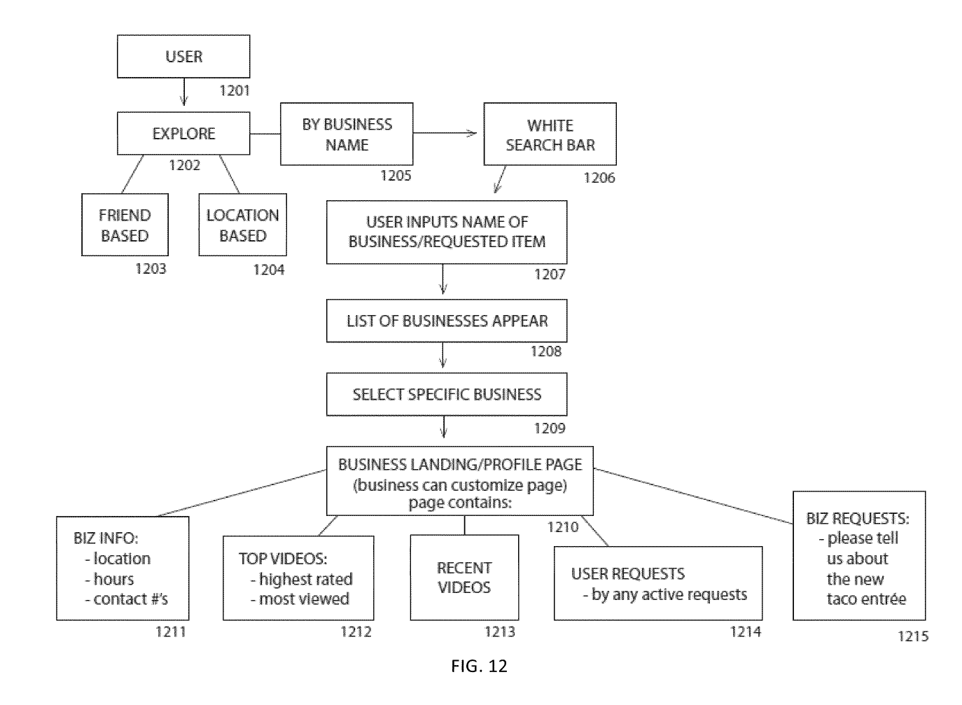

The mobile application and/or system may have programming configured to enable the subscriber to search for business subscribers by name (311). As a method of incentivizing subscribers to generate fliks and otherwise participate in the system, the mobile application and/or system may be configured to provide alerts to subscribers about businesses subscribers. The alerts may include discounts (317) offered at the establishments of business subscribers, for instance, establishments in close geographic proximity to the subscriber as determined by information transmitted from the mobile device. Further, business subscribers may offer incentives to a subscriber in return for the subscriber referring business to the business subscriber or generating a flik favorable to a product or service offered by the business subscriber. The mobile application and/or system may have programming enabling a business subscriber to create an alert that may be broadcast via the system. For instance, as shown in FIG. 3, via programming in the system, a business subscriber may generate an alert in the form of a task (318) offering a subscriber “a free drink” if the subscriber generates five fliks (319). The incentives may include an award system (i.e., points) which a subscriber may earn and later redeem to receive merchandise or other services (320). The system may be configured to enable the business to generate a message to be received by the subscriber's mobile device 102 indicating that the subscriber mobile device user earned a reward (321). A further discussion of this functionality follows below in reference to the discussion of FIG. 12.

The mobile application and/or system may have programming configured to enable the subscriber to search for locations (312). The mobile application may interact with the system and the mobile application and/or system may have programming to enable the subscriber via the mobile device to determine activity and interest levels (313) in a location proximate to the subscriber's location and to search for promotions offered near the subscriber's location (316). The promotions may involve alerts in the form of tasks (318) as described above.

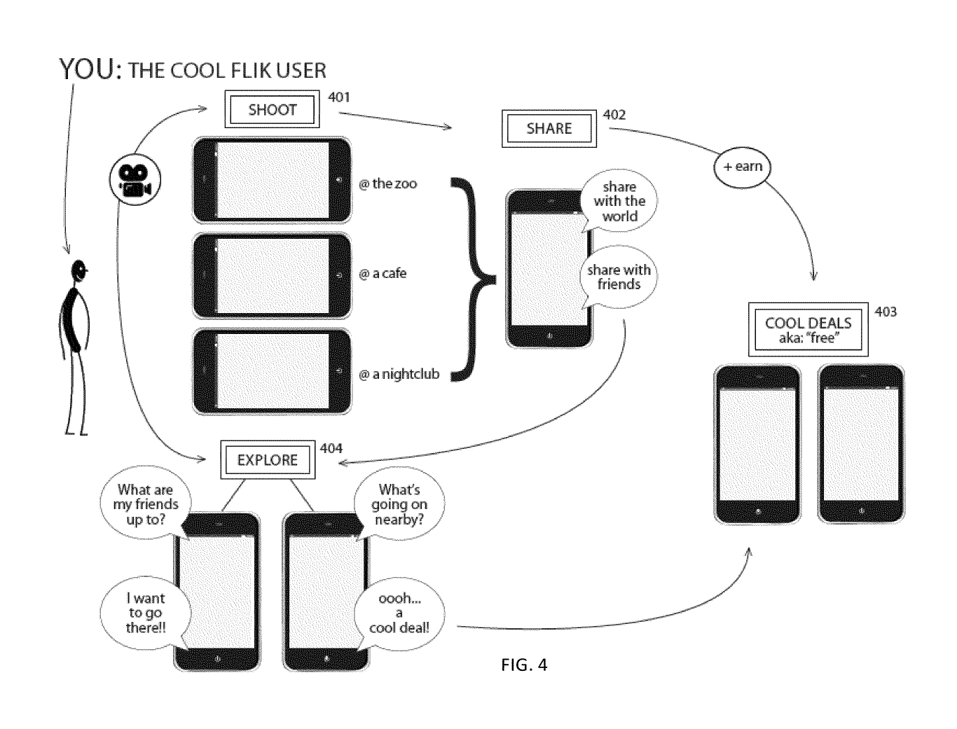

FIG. 4 shows another illustration of the process by which a user interfaces with the system. At step 401, the subscriber generates a flik. For instance, the subscriber may generate a flik while visiting the zoo, a café, or a night club. At step 402, the user may upload the flik to the system. The user may share the flik with friends or may share the flik with a broader audience or subscribers of the system. As described previously, the system may enable business subscribers to incentivize subscribers to generate fliks. At step 403, the system enables a business to generate an incentive that is provided via the system to a subscriber to generate a flik favorable to the business in return for offering the subscriber a reward. At 404, a subscriber may search via the mobile application and/or system to find activities taking place in a close geographic proximity to the subscriber that the subscriber may be interested in, including frequenting a business establishment to redeem a reward. The mobile application and/or system may also be configured to enable the subscriber to search and locate other subscribers and view other subscriber's fliks.

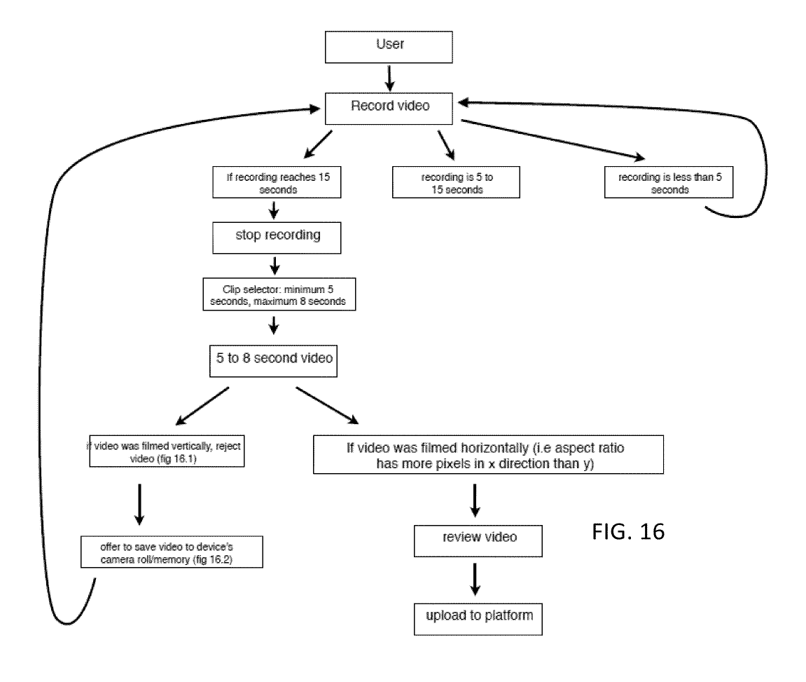

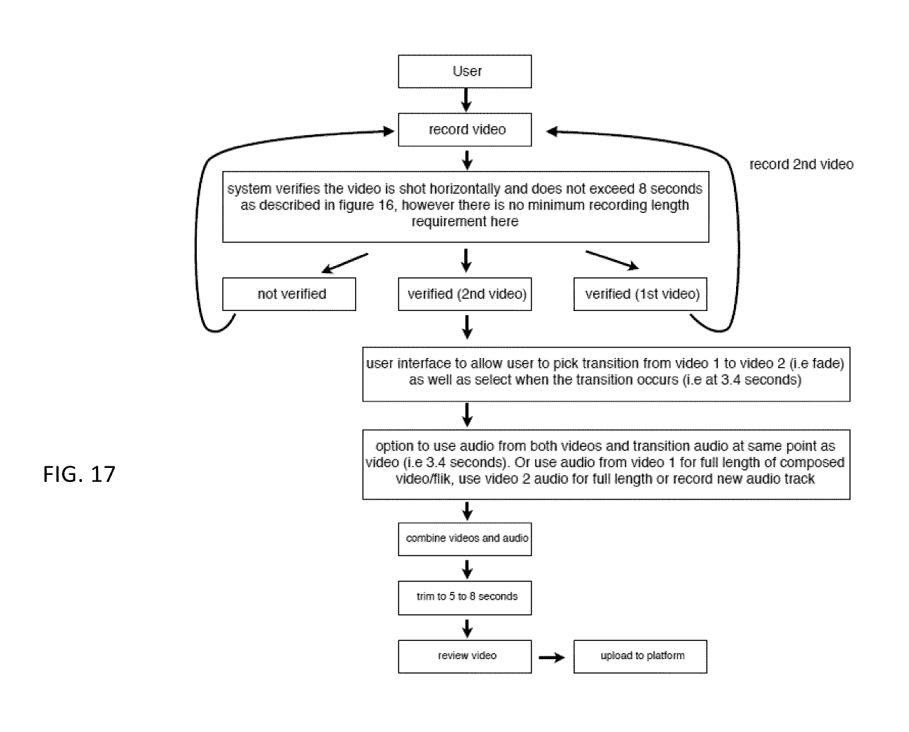

FIG. 5 is a flow chart illustrating the process by which a subscriber sets parameters for generating a flik before it is uploaded. As described earlier, the mobile application includes a viewing portal. Programming associated with the viewing portal may be enabled to allow the subscriber to set parameters for generating the flik (502). For instance, the mobile application may have programming configured to present a display suggesting to the subscriber that the flik has a limited length. For instance, as shown in 503, the programming may be configured to generate a message stating “your video is limited to 7 seconds maximum length.” The programming may be configured to allow the subscriber to elect whether the subscriber wishes to edit the flik to reduce the length to within the prescribed limit. As shown in FIG. 5, if the video is longer than 7 seconds (504), the programming may be configured to enable the subscriber to edit the flik (505,506). Alternatively, the programming may be configured to enable the user to automatically stop the generation of the flik at the prescribed limit (507). The programming may then enable the subscriber to review the video (508) before uploading the flik to the system (509). The programming may also allow other editing of the flik. For instance, additional editing functions are described below in reference to FIGS. 16 and 17.

FIG. 6 shows the process by which a flik generated on a mobile phone may be uploaded to the system. As shown in FIG. 6, the subscriber may utilize the mobile application on the mobile phone 602 and upload a flik to the system via a cellular communications data network (603); via a WIFI connection associated with the mobile phone (604); via a flik configured WIFI connection associated with a business subscriber (605); or via a flik kiosk or stand (606). Either of the methods enable the subscriber to access the internet and upload the flik to the system. As shown in FIG. 6, each of the communication paths interfaces with the internet 607 and enables the mobile user to share the flik among a selected group of subscribers (i.e., “private sharing” among “friends” (608)) or a wider audience of subscribers (i.e., “public sharing” (609)).

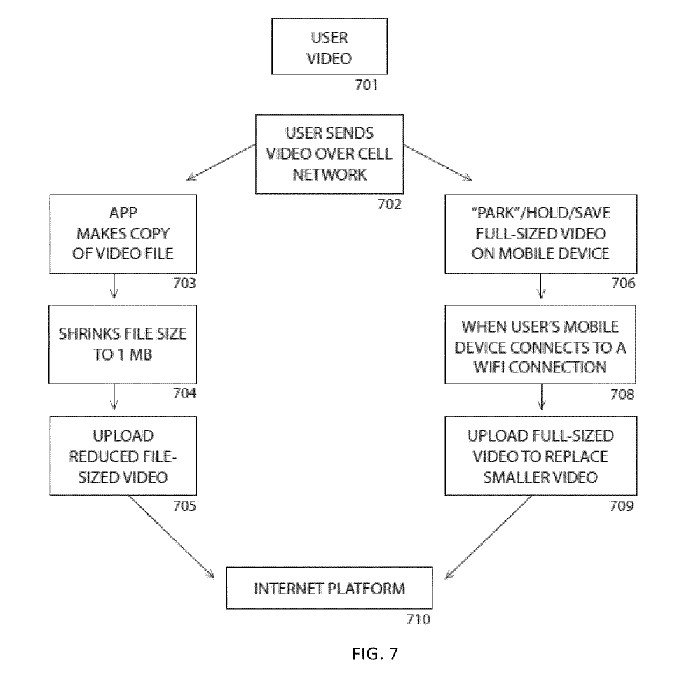

FIG. 7 is a flow chart illustrating the process by which the user's generated flik may be uploaded to the system via a cellular network (i.e., step 603 of FIG. 6). The programming may be configured to enable the mobile application to make a copy of the video file (703). The programming may compress the file size to a prescribed limit to enable the flik to be transmitted through a cellular network with optimization of bandwidth. For instance, as shown in FIG. 7, the mobile application may have programming enabling the flik to be compressed to a file size of one megabyte (1 Mb) to enable it to be transmitted over a cellular network without significantly impacting bandwidth (704). Once the mobile application compresses the file size to a prescribed limit (704), the file may be uploaded (705) and transmitted to the internet (710). In addition to, or in the alternative, the mobile application and/or system may have programming to transmit the flik to the internet once the user accesses a WIFI connection. For instance, as shown in FIG. 7, the flik may be parked and saved on the subscriber's mobile device (706). When the subscriber's mobile device connects to a WIFI connection, the mobile application may have programming configured to upload the full length flik to the internet (707). The full length flik may then replace the compressed flik uploaded to the system via the cellular network previously (708). In this way, the quality of the flik may be preserved while enabling the subscriber to generate a flik in real time without the delay or waiting for a WIFI connection.

FIG. 8 shows a flow chart illustrating the process by which a subscriber may upload a flik to the system utilizing a flik configured WIFI connection associated with a business subscriber. A business subscriber may have a WIFI connection especially adapted for use with the system. For instance, the business subscriber may include in a standard WIFI system hardware and/or software configured to communicate with the system to allow a flik to be tagged as it is generated. As shown in FIG. 8, as the subscriber generated flik is transmitted to the system through the business subscriber's flik configured WIFI connection, flik related data associated with the business is generated and attached to the file of the flik. As mentioned before, the flik related data attached to the video file (803) may be associated with the commercial data structures, subscriber data structures, video data structures, or other custom data structures. The custom data structures may include the business name, business location, date/time stamp, product information, and other tags that the business wishes to include with the transmission of the flik to the internet to allow the flik to be associated with the business subscriber in a desired manner. Once the flik is uploaded to the system (804), the system may have programming configured to display the flik on the business subscriber's profile page (805). Additionally, the system may have programming configured to present the flik on a home page associated with the system (“newest uploads”) (806). Additionally, the system may have programming configured to enable the flik to appear on other application programming interfaces, widgets, and other websites and other web hosting platforms.

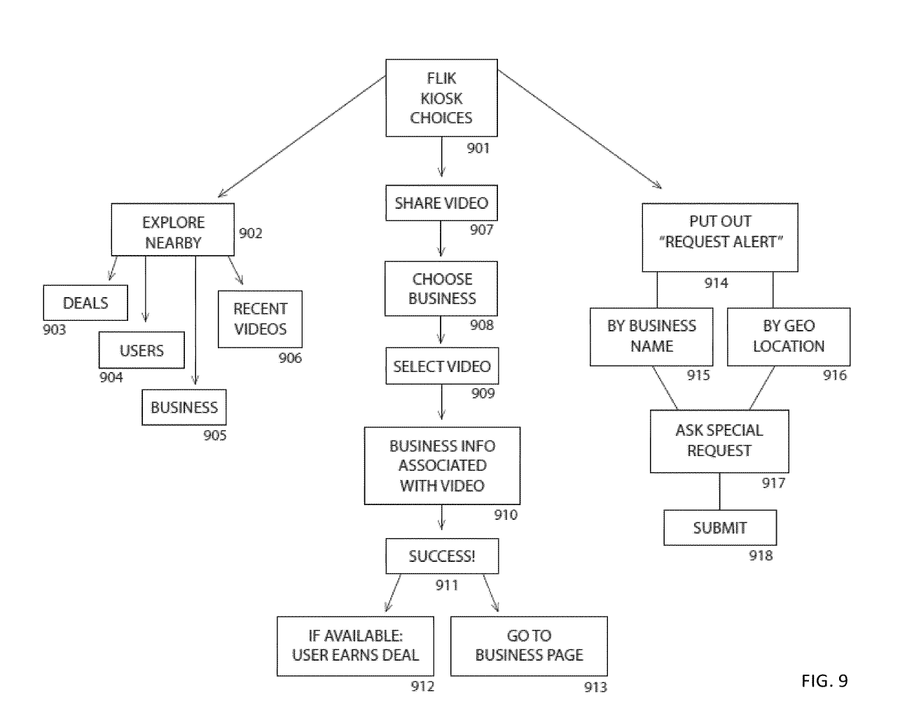

FIG. 9 is a flowchart illustrating the process by which a subscriber may upload a flik to the system via a flik kiosk or stand (step 606 of FIG. 6). As shown in FIG. 9, a flik kiosk or stand may comprise programming to enable the subscriber to accomplish several tasks. First, the flik kiosk or stand may have programming configured to enable the subscriber to search (902). The kiosk or stand may have programming configured to present a display indicating promotions, prizes, or other incentives that a subscriber may be interested in redeeming based upon rewards the subscriber has earned (903). The search functions may include programming configured to enable the subscriber to identify and locate other subscribers (“friends”) (904). The programming may be configured to enable the subscriber to search for business establishments subscribing to the system (905). The kiosk or stand may also have programming configured to present to the subscriber recent fliks generated by other subscribers, including subscribers within the subscriber's selected group (“friends”) (906).

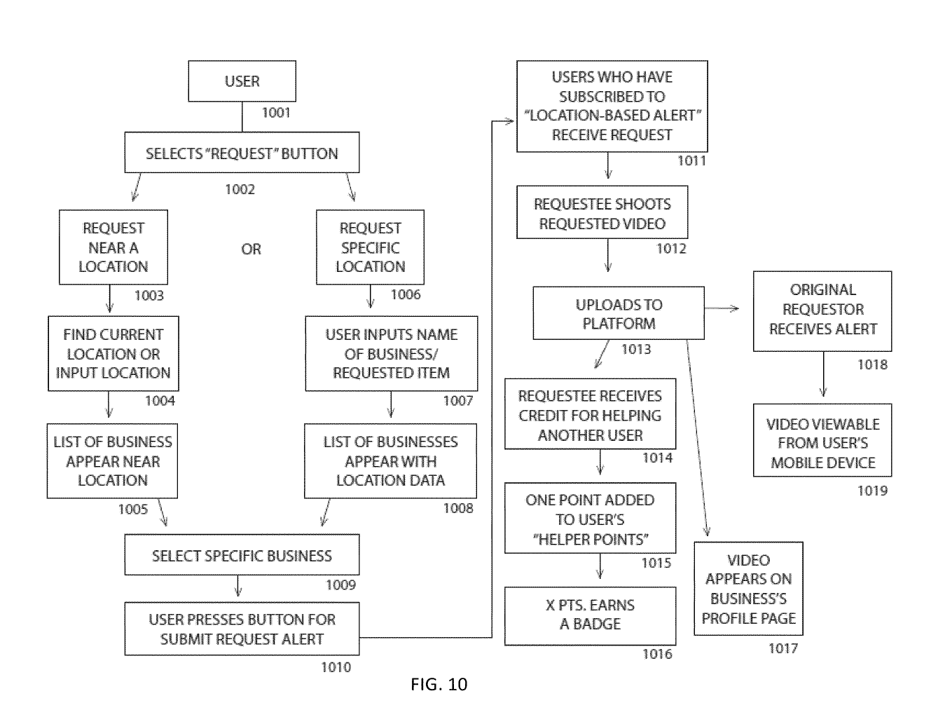

The flik kiosk or stand may also have programming configured to enable the subscriber to upload a flik to the system. For instance, at the kiosk or stand, the subscriber may upload a flik in the manner previously described in reference to FIG. 6. Also, a flik kiosk or stand may also have programming configured to enable the subscriber to access fliks previously generated by the subscriber and redistribute the fliks (907). For instance, the kiosk or stand may have programming sufficient to enable the subscriber to attach and upload business information and other data with a previously-generated flik. As described previously with respect to FIG. 8, the data may include a business' name, location, a date/time stamp, product information, or other tags that the business may select or that the user may desire to include from a customized list. To incentivize subscribers to utilize the functionality of a kiosk or stand, the kiosk or stand may be provided in close proximity to the establishments of subscribing businesses. In that regard, a subscribing business may further incentivize a subscriber to generate a flik favorable to the business, its products or services. For instance, as shown in FIG. 9, the kiosk or stand may be configured with programming that enables a subscriber user to earn a reward for utilizing the kiosk or stand (912). Alternatively, the kiosk may have programming to present a display that directs the subscriber using the kiosk to the business subscriber's profile page where the subscriber may access coupons or other rewards (913). In the alternative, or in addition to, the flik kiosk or stand may have programming configured to enable a subscriber to request alerts (914). The requested alerts may be based upon a business name (915), or a geographic location (916). Once the subscriber requests an alert, the system may have programming configured to transmit the request to other subscribers in close geographic proximity to the requestor subscriber (917). Another subscriber receiving the request may generate a flik or stand in response to the request and upload the flik to the system (918). A further discussion of this aspect of the kiosk functionality follows below in reference to the discussion of FIG. 10.

FIG. 10 shows the process by which a user may generate an alert request at a flik kiosk or stand. As described above, a subscriber may access a flik kiosk or stand (1001) and elect to have an alert request made (1002). A request may be based upon the subscriber being located near a specific location (1003) or based upon a specific location (1006). If the subscriber chooses near a specific location (1003), the kiosk may have programming configured to determine the subscriber's current location or the kiosk may be configured with programming to present a display to allow the subscriber to input a location (1004). The kiosk or stand may then have programming configured to retrieve from a database a list of businesses located near to the subscriber's location (1005). The kiosk or stand may also have programming to present a display to allow the subscriber to select a business from a list of businesses (1009).

Alternatively, the subscriber may input the name of a business or a requested item (i.e., “a free drink” (1007)). A kiosk or stand may have programming configured to access a database associated with the system, and programming sufficient to present a display with a list of businesses corresponding to the request made by the subscriber along with location data associated with the business (1008). The kiosk or stand may also have programming to present a display to allow the subscriber to select a business from a list of businesses (1009).

The kiosk or stand may have programming configured to present a display for the user to submit an alert request (1010). The alert request could take the form of the subscriber asking other subscribers in and around the subscriber's location about activities in the area, a specific business, a review on a business, a review of a product or service, or conditions at a venue. The system may have programming to generate alert requests which may be transmitted via the system to other subscribers based upon their location. The requests may request that the other subscribers generate fliks based upon their commercial experiences at the locations identified in the request. For instance, as shown in FIG. 10, after a subscriber submits an alert request (1010), other subscriber who have subscribed to location-based alerts receive the requests via the system (1011). A subscriber receiving the request may generate a flik based upon his or her current commercial experience at an establishment. Utilizing the processes described previously with reference to FIG. 6, the subscriber receiving the request may upload a generated flik to the system (1013). The corresponding flik may appear on the business subscriber's profile page in accordance with the discussion made in reference to FIG. 8 (1017). To provide further incentives to the subscriber receiving the alert request for helping another subscriber, the subscriber receiving the alert request and generating the flik may receive credits which may be redeemed toward an award (1014, 1015, 1016). Additionally, the system may have programming configured to send an alert request to the original requesting subscriber (1018). The system may have programming configured to enable the original requesting subscriber to access the generated flik via the subscriber's mobile device (1019), thereby allowing the subscriber to review the flik generated in response to the alert request.

In one example, a flik kiosk or stand may be provided in a mall. The subscriber may access the kiosk to submit a request asking for subscribers in the mall for their current commercial experiences at a retail establishment. Other subscribers on the system may receive the location-based alert and generate a flik which may be uploaded to the system. The flik may then be transmitted through the system and the requesting subscriber will receive an alert with access to the generated flik on their mobile device or via the kiosk. In return for the other subscriber generating the flik, the other subscriber may receive credits. Also, the generated flik may appear on the business establishment's profile page.

A further illustration of alerts follows below by way of example. The system and/or mobile application may have programming configured to allow a subscriber to choose a level and the types of alerts for requests they would like to receive. For example, a subscriber may specify the maximum number of requests he or she would like to receive in the course of a time period (i.e., a “counting limit” preference). The system and/or mobile application may have programming configured to allow a subscriber to specify filters based on proximity of a location of which a flik request was issued to either a current location or a specified location (i.e., a “location proximity” preference). The system and/or mobile application may also have programming configured to allow a subscriber to specify for what genre of venues they prefer to receive alerts (e.g., restaurants, concerts, sightseeing, etc.) (the “venue genre” preference). The system and/or mobile application may have programming configured to allow a subscriber to specify favorite places from which he or she would want to see alert requests (the “venue specific” preference). In one embodiment, the system and/or mobile application may have programming such that the venue specific preference trumps the counting limit, proximity limit, and venue genre preferences.

A further example is provided in the context of User 1. User 1 generates an alert request to see what the scene is like at Sprinkles Cupcakes. The system has programming configured to determine whether the alert should be sent to any or all of Users A, B, C, D.

1. User A specifies he wants no more than 5 alerts in a day for requests that are within 2 miles of his residence (123 Main St., Chicago, Ill. 60601). He prefers alerts about restaurants and sports arenas and set the venue genre preference accordingly. “Girl and the Goat” and the “United Center” are his favorite venues for which he would prefer to see requests. The venue specific preference is set accordingly.

Because (a) Sprinkles Cupcakes is within 2 miles of his residence, (b) is considered a restaurant, and (c) User A has received no alerts today and is not close to counting limit preference, the system will send the alert to his device, although Sprinkles Cupcakes is not a favorite venue.

2. User B specifies she wants no more than 5 alerts in any given hour that are within 1 mile of where she is at any given point in time (based on her current location—GPS). She likes alerts about concerts. She has no venue specific preference set.

Because User B has received 4 alerts this hour and is currently not within 1 mile of Sprinkles Cupcakes, the system will not send an alert to her device.

3. User C specifies she wants no more than 2 alerts per day on the Thursday, Friday, Saturday and Sunday, and none on Monday, Tuesday or Wednesday, and she want alerts anywhere in Downers Grove (60515). Her favorite places are “Emmitt's Ale House,” “Every Day's a Sundae,” and “The Tivoli.” The venue specific preference is set accordingly.

Because it is a Monday, the system does not send User C an alert.

4. User D specifies a counting limit of 0 and gives no location filter for alerts. He has no venue genre preference, but chooses to see all alerts that are made for “Perennial Virant,” “Lululemon Halsted,” and “Sprinkles Cupcakes.” The venue specific preference is set accordingly. User D may allow the specific alerts supersede his counting limit preference.

Because User D has specified he wants an alert about any request being created about Sprinkles Cupcakes, the system will send the alert to his device.

A further example is provided in the context of User 2. User 2 generates an alert request to see what the scene is like at “Girl and the Goat”. The system has programming configured to determine whether the alert should be sent to any or all of Uses A, B, C, D.

1. User A specifies he wants no more than 5 alerts in a day for requests that are within 2 miles of his residence (123 Main St., Chicago, Ill. 60601). He prefers alerts about restaurants and sports arenas and set the venue genre preference accordingly. “Girl and the Goat” and the “United Center” are his favorite venues for which he would prefer to see requests. The venue specific preference is set accordingly.

Because User A has received 5 alerts already today, the counting preference takes precedent and the system will not send User A an alert. Had User A specified his favorite venues would supersede his counting limit preference, the system would have sent User A an alert.

2. User B specifies she wants no more than 5 alerts in any given hour that are within 1 mile of where she is at any given point in time (based on her current location—GPS). She likes alerts about concerts. She has no favorite venues set up. The venue specific preference is set accordingly.

For the example, it may be assumed that the system has sent User B one alert this hour and the system has determined her current location to be within a mile of “Girl and the Goat”. Although she prefers concerts per the venue genre preference, User B has not reached the counting limit preference and still has 4 more alerts for the hour. Accordingly, the system may be configured to send an alert to her device.

3. User C specifies she wants no more than 2 alerts per day on the Thursday, Friday, Saturday and Sunday, and none on Monday, Tuesday or Wednesday, and she want alerts anywhere in Downers Grove (60515). She has no venue genre preference. Her favorite places are “Emmitt's Ale House,” “Every Day's a Sundae,” and “The Tivoli.” The venue specific preference is set accordingly.

For the example, it may be assumed that the system has not sent User C an alert today and it is a Friday. Because “Girl and the Goat” is not in Downers Grove (60515), the system will not send User C an alert.

4. User D specifies a counting limit of 0 and gives no location filter for alerts. He has no venue genre preference, but chooses to see all alerts that are made for “Perennial Virant,” “Lululemon Halsted,” and “Sprinkles Cupcakes.” The venue specific preference is set accordingly.

Because “Girl and the Goat” is not a venue specific favorite of User D, the system does not send User D an alert.

Through the use of preferences and an evaluation of subscriber tendencies, the system may be configured to provide interesting “suggestions” through alerts to subscribers.

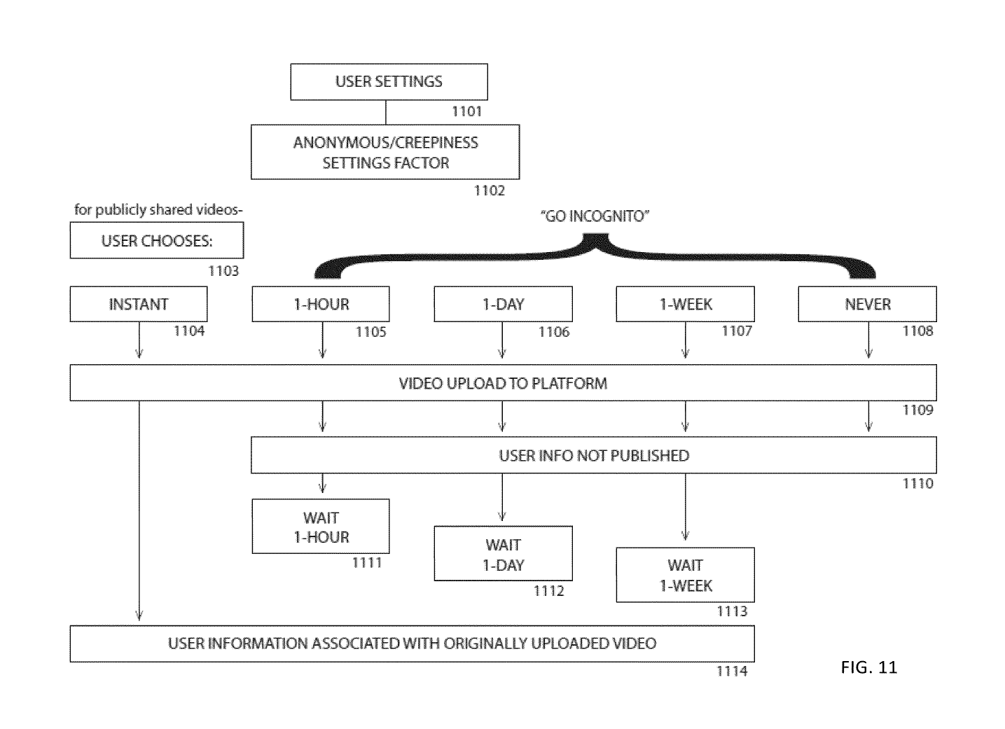

FIG. 11 shows a flow chart illustrating the process by which a subscriber may choose to publicly share a flik. As discussed before in reference to FIG. 3, a subscriber may share a video publicly to provide a commercial experience with a business, company, or event. To allow the subscriber to avoid potential awkwardness with posting a flik, the mobile application and/or system may have programming configured to enable the subscriber to select the time at which the video will be uploaded to the system. For instance, as shown in FIG. 11, the subscriber may select specific times at which the video will be uploaded to the system (1104, 11-05, 1106, 1107, 1108). For instance, the mobile application may be configured to enable the subscriber user to instantly upload and publicly share a flik (1104). Alternatively, the mobile application and/or system may have programming configured to allow the subscriber to select a time period when the flik may be uploaded to the system. For instance, as shown in FIG. 11, the selections may include “one hour,” “one day,” “one week,” and “never” (1105, 1106, 1107, 1108). Additionally, the mobile application and/or system may have programming that is configured to enable the subscriber to select whether or not the subscriber's identification information will be published (1110). The mobile application and/or system may have programming configured such that if the subscriber elects to publish the subscriber's information, the subscriber may select a time period when the subscriber's identification information may be published, which may occur after the video is loaded to the system. For instance, as shown in FIG. 11, the mobile application may be configured with programming to allow the subscriber to select “one hour,” “one day,” or “one week” (1111, 1112, 1113). In addition to or alternatively, when the user elects to instantly publish a flik to the system (1104), programming may enable the subscriber's information associated with the originally uploaded flik to be instantly provided to the system and published on the system.

As described previously, a subscriber interacting with the system may conduct searches for businesses subscribing to the system. As shown in FIG. 12, a subscriber may conduct a search via the system. The system and/or mobile application may have programming configured to enable the subscriber to search for selected subscribers or groups of subscribers currently logged into the system (“friends”) (1203). The system and/or mobile application may also have programming configured to enable the subscriber to search based upon the subscriber's location as determined by data transmitted from the mobile device. For instance, a subscriber may wish to search for others in a location or subscribing businesses in a location to find out whether any businesses are offering promotions nearby the subscriber's location or to learn what activities others are engaged in at locations near to the subscriber's location (FIG. 3; 312,313,316). Additionally, the mobile application and/or system may have programming sufficient to enable the subscriber to search by business name (1205, 1206). For instance, the mobile application may have programming that presents the display of a search bar (1206) that enables the user to input the name of a business or to input a request (1207). The system and/or mobile application may have programming configured to access a database of subscribing businesses and programming configured to present a display of a list of subscribing businesses located near the subscriber's location as determined from data transmitted from the subscriber's mobile device (1208). The system and/or mobile application may have programming configured to present a display that allows the subscriber to select a specific business among the list of businesses displayed (1209). The system and/or mobile application may have further programming that redirects a subscriber to a business profile page after selecting a specific business (1210). Once at the business profile page, the subscriber may access specific information about the business (1211), and/or other fliks generated by subscribers that relate to the business (1212). The information on other fliks may include ratings and viewership. Additionally, the subscriber may access recently generated fliks associated with the business (1213). The subscriber may also look at requests made by other subscribers and fliks associated with the business (1214). At the business profile page, the subscriber may also review requests by the business seeking reviews on new products or asking the subscriber to provide a flik.

FIG. 13 is a flowchart illustrating the process by which a user may search for other subscriber users on the system including groups of subscriber users designated by the subscriber user as “friends”. The system and/or mobile application may have programming configured to display a search bar with a field for the subscriber to input information to search for another subscriber. The system and/or mobile application may have programming configured to access a database and provide a listing of other subscribers in a selected group or a specific subscriber. The system and/or mobile application may have programming configured to present a display of another subscriber's profile page (1305). Further, the system and/or mobile application may have programming configured to display a drop-down menu to allow the subscriber to access a specific subscriber's profile page (1307). The display may include an array of most recent fliks generated by the other subscriber. The display may include thumbnail images of the flik. The programming may be configured to allow the subscriber to hover over a particular thumbnail image of a flik and ascertain information on the flik including the individual responsible for generating the flik and other information associated with the flik (i.e., a business name, time, location, etc.). Further, the system and/or mobile application may have programming configured to enable the subscriber to play a specific flik, for instance, by accessing the thumbnail image of the flik. An example of a subscriber profile page is shown in FIG. 13 at step 1309. In a like manner, a subscriber may conduct searches based upon location. For instance, a municipality or other agency may generate a profile page, and a subscriber may access the municipality's or agency's profile page through location based searching.

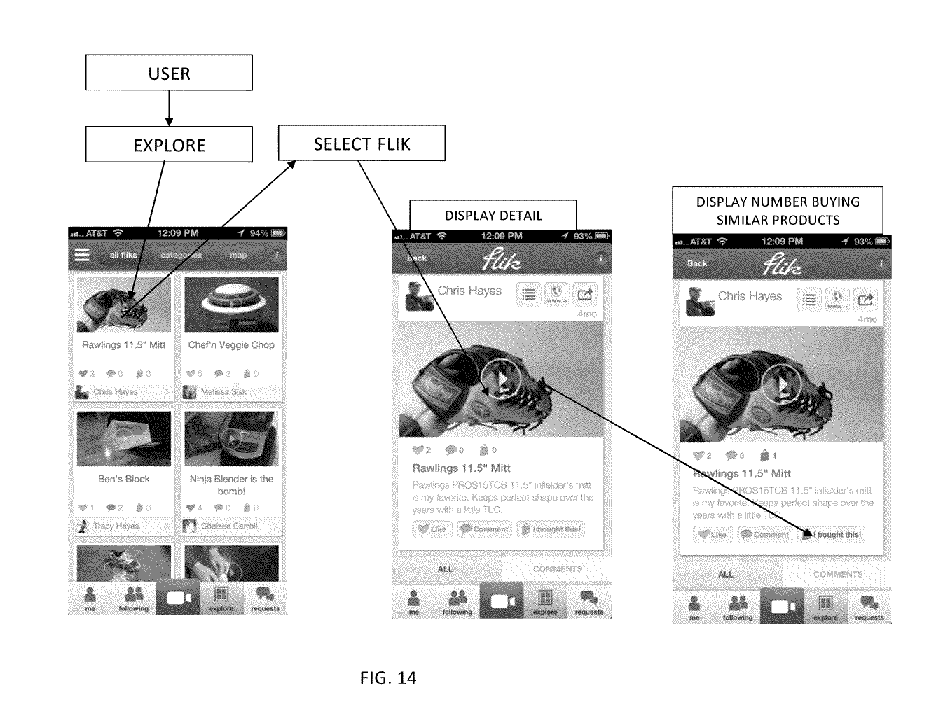

FIG. 14 provides additional detail of another application by which a user may search for other subscriber users on the system and receive information regarding products and services purchased by other subscribers on the system. For instance, the system may have programming enabling a user to view the display of another subscriber's profile page and a flik about a product recently purchased by the other subscriber. The system may have programming configured to indicate to the user how many other subscribers have purchased similar products or services, or visited a business establishment. For instance, the system may have programming configured to display a dialog box below the thumbnail of the flik about the product, and the dialog box may display the number of other subscribers that have purchased similar products in addition to the subscriber. The system may also have programming to display in the dialogue box the number representative of the number of other subscriber that have commented favorably or unfavorably on the product or service, or business establishment.

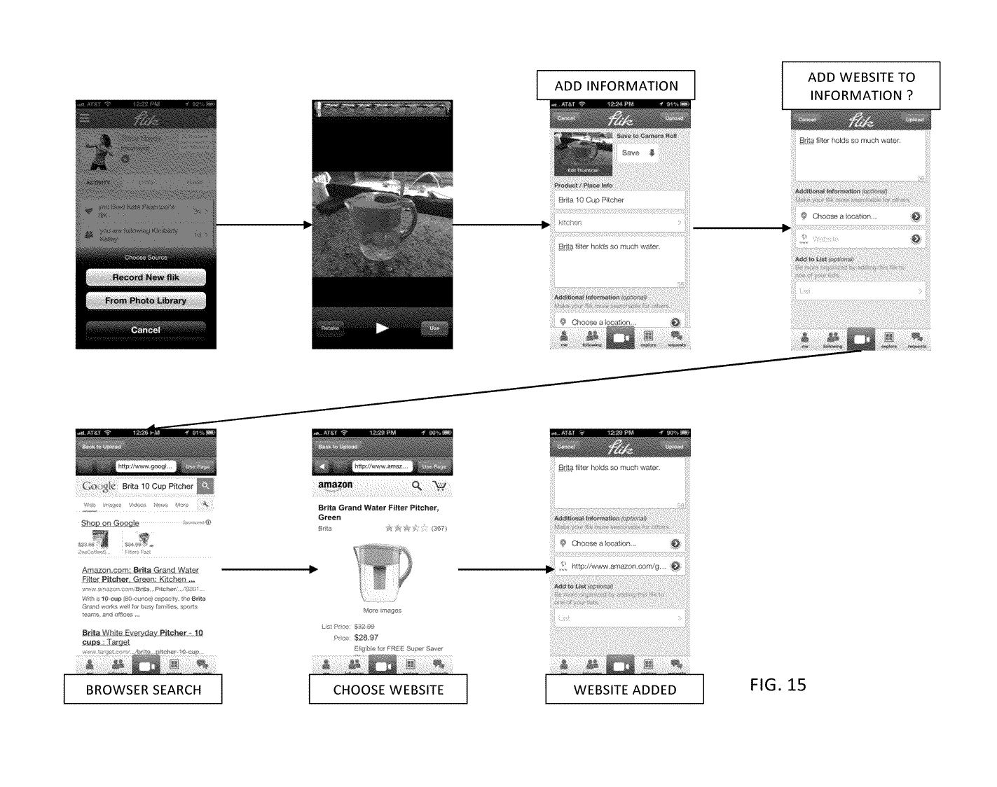

Additionally, the system may have programming enabling the subscriber to associate a web address with a flik. FIG. 15 shows a process flow diagram illustrating the process of associating a web address with a flik. The system may have programming enabling a user to use a browser on their mobile device or computer to search for possible website links to associate with the flik. The system may include programming to enable the user to scroll through a list of returned search results and to allow the user to select the most appropriate search result to associate with the flik.

FIG. 16 shows a process flow diagram illustrating the process utilized by the system for processing video images. To provide uniformity throughout the system on user generated fliks, the system may have programming to determine whether a flik was generated in a portrait or landscape mode (i.e., vertically or horizontally) by determining the number of pixels in the x and y axis. The system may have programming allowing a user to modify the flik so that it is consistent. Alternatively, the system may have programming to display dialog box inviting the user to re-take the flik when the flik is not in conformity. The process illustrated in FIG. 16 shows programming associated with the processor that determines whether the flik was filmed vertically or horizontally. Once the processor determines that the flik was filmed vertically, the flik is rejected and the user is invited to retake the flik and/or save the flik to the camera roll for use on the mobile device rather than in the system.

FIG. 17 shows a process flow diagram illustrating additional functionality associated with the system that enables a user to combine two videos into a composed video to be posted as a flik. This feature enables the user to have the option record two videos and then have the videos transition from one to the other to create a new composed video to be posted as a flik. The composed video may be uploaded as a flik in the manner described previously. The system may have programming to allow the user to utilize the audio of one of the videos or both of the videos with the composed video to be posted as a flik. Alternatively, the system may have programming to allow the user to utilize a new audio track with the composed video to be posted as a flik.

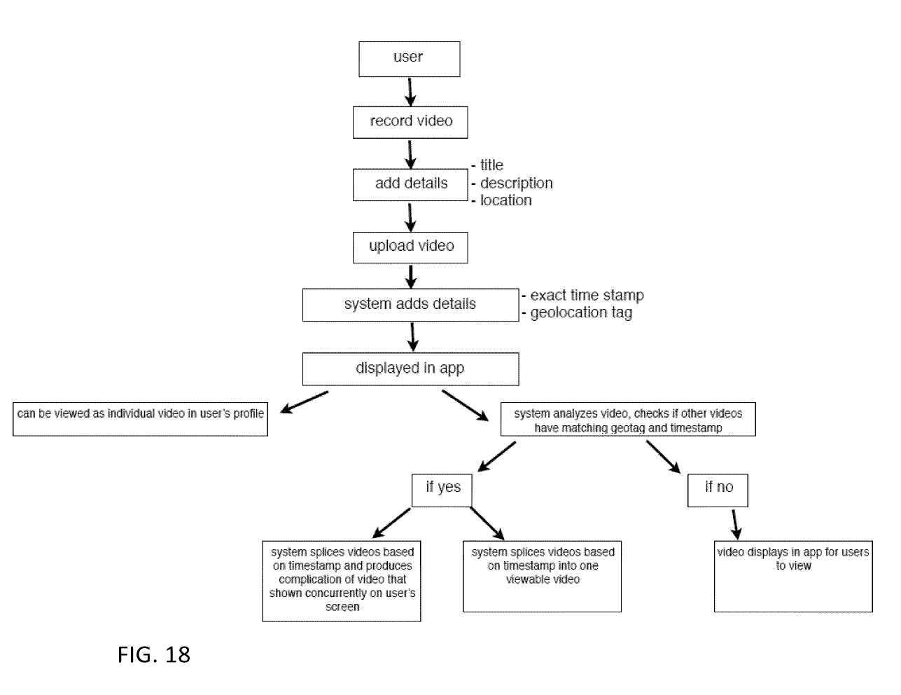

FIG. 18 illustrates a process whereby the system may have programming to analyze video generated by many users of the system based upon timestamp and geographical information and provide options for display of the video to users of the system. The video may be of limited short duration (i.e., less than 15 seconds), a flik as previously disclosed, or a video of any length. As shown in FIG. 18, a user may record a video using a mobile device. The system may have programming to display a graphic user interface to allow a user to add a data structure to the video, including, by way of example, and not in any limiting sense, a title, description, or location. The video may be uploaded to the system as a flik. The system may have programming to add additional data structures to the video, including, by way of example, and not in any limiting sense, a timestamp and geographic location information. The system may have programming to display to the user in a graphic user interface associated with the user's mobile device the video for playback and editing, and the data associated with the video. The system may have programming to enable the user to view and access the video with data associated with the video at the user's homepage or landing page. The video may be uploaded to the system and be available for access by other users of the system in accordance with the preferences selected in the user's profile. The system may have programming to allow the system to analyze the data structures associated with the video. The system may have programming to provide to users of the system the videos of many users based upon similar geographical location data, and either similar or successive time stamp data. For instance, the system may have programming to provide thumbnail images of the videos to graphic user interfaces of mobile devices associated with users. The thumbnail images may be representative of videos having the same time stamp and geographic location data and thus represent videos taken by many users concurrently of the same event. Alternatively, the system may have programming to sequence videos with the same geographical location data based upon successive time stamp information to provide a compilation video comprising the videos of the many users sequenced based upon the timestamp data. The system may have programming to prompt the user to upload videos with dissimilar geographic location data and/or timestamp information to storage of the user's mobile device or to the system as fliks. The system may have programming to allow the user to edit a video to a set length to upload to the system as a flik.

The system may have further programming configured to collect and analyze fliks to categorize the fliks and identify trends and patterns in pre-determined markets. Data associated with the generated fliks may be collected and analyzed. Based upon the volume, nature, and content of the fliks, marketing and promotional information may be provided to businesses subscribing to the system. For instance, the identity of subscribers posting fliks may be evaluated and the various roles that subscribers play in the system in posting fliks may be further evaluated to provide additional information of credible evaluators of businesses, products, and services. The identity of subscribers whose postings tend to produce other fliks or whose fliks have large viewership may be tracked and evaluated. Subscribers may be classified in accordance with the amount of “buzz” created regarding a business or a product or service Ratings may be assigned to subscribers generating “buzz” based upon fliks directed to a specific business or product. The audio track associated with a flik may be analyzed for content. Based upon the words used in the audio portion of the flik, analytics and other metrics may be tracked and correlated. The information may be provided to businesses to assist the businesses in evaluating trends and forecasting, business reputation and brand recognition.

While various embodiments have been described above, it should be understood that they have been presented by way of example only, and not limitation. Thus, the breadth and scope of a preferred embodiment should not be limited by any of the above-described exemplary embodiments.

What is claimed is:

1. A system for disseminating information about a user's experience with an entity:
a system processor for communication with a plurality of remote computers via a network, the system further comprising a memory, the system processor being configured to:
store a data structure in the memory, the data structure comprising a plurality of data items representative of a profile of the user, a profile of the entity, and a video representative of the experience of the user with the entity;
receive video data from at least one of the plurality of remote computers, the video data being representative of the user's experience with the entity;
associate the video data with the profile of the user and the profile of the entity to generate the data structure; and
provide experience data to a plurality of remote computers via the network in accordance with criteria associated with the user profile and the entity profile, the provided data pertaining to the user profile, the entity profile, and the video data representative of the experience of the user with the entity.

2. The system of claim 1, wherein the video data comprise a video of no more than 15 seconds.

3. The system of claim 1, wherein the data associated with the entity profile comprises at least one of a business name, business location, business contact information, business hours, business website, business genre, product name, business rating, product rating, business website, and a number of users favorably associated with the business.

4. The system of claim 1, wherein the data associated with the user profile comprises at least one of a user's name, and the identity others accompanying the user.

5. The system of claim 1, wherein the data associated with the video representative of the experience of the user interacting with the entity comprises at least one of a time stamp, a location where the video was taken, information about whether a user liked the entity.

6. The system of claim 1, wherein the system processor is further configured to generate a home page associated with the user profile.

7. The system of claim 6, wherein the data associated with the video representative of the experience of the user interacting with the entity comprises programming data to enable the execution of instructions to post a video comprising the video data to the home page associated with the user profile.

8. The system of claim 1, wherein the system processor is further configured to generate a home page associated with the entity profile.

9. The system of claim 8, wherein the data associated with the video representative of the experience of the user with the entity comprises programming data to enable the execution of instructions to post a video comprising the video data to the home page associated with the entity profile.

10. The system of claim 1, wherein the criteria associated with the user profile includes access rights to the video data.

11. The system of claim 10, wherein the criteria associated with the user profile includes time based delivery instructions for the video data.

12. The system of claim 10, wherein the data associated with the video representative of the experience of the user with the entity comprises programming data to enable the execution of instructions enabling other users of the system to comment on the video.

13. The system of claim 10, wherein the data associated with the video representative of the experience of the user interacting with the entity comprises programming data to tabulate the total number of users of the system who have viewed the video.

14. The system of claim 1, wherein the system processor is further configured to generate storage and retrieval data and associate the storage and retrieval data with the video.

15. The system of claim 1, wherein at least one of the remote computers on the network comprises a mobile device.

16. The system of claim 15, wherein the system processor is further configured to determine the geographic location of a user based upon signals transmitted by the mobile device associated with the user profile.

17. The system of claim 16, wherein the system processor is further configured to provide entity profile information to the user based upon the geographic location data transmitted by the mobile device.

18. The system of claim 17, wherein the provision of the entity profile information is initiated via a signal transmitted by the user's mobile device.

19. The system of claim 17, wherein the entity information provided to the user includes an incentivized message for the user to interact with the entity.

20. The system of claim 17, wherein the provision of the entity profile information is based upon preferences associated with the user profile.

21. The system of claim 1, wherein at least one of the remote computers on the network comprises a kiosk.

22. The system of claim 21, wherein the kiosk comprises a display configured to display data pertaining to the entity profile in response to a kiosk user selection.

23. The system of claim 22, wherein the entity information provided to the kiosk user includes an incentivized message for the kiosk user to interact with the entity.

24. The system of claim 22, wherein the display is configured to present to a kiosk user a video representative of the experience of another user interacting with an entity.

25. The system of claim 22, wherein the kiosk comprises a kiosk processor enabling a kiosk user to transmit video data via the network to be received by the system processor.

26. The system of claim 22, wherein the system processor is further configured to provide entity profile information to the kiosk via the network based upon geographic location data transmitted by a mobile device associated with another user of the system.

27. The system of claim 1, wherein the system processor is further configured to provide entity profile information to the user based upon user preference data associated with the user profile.

28. The system of claim 1, wherein the system processor is further configured to provide entity profile information to the user based upon search queries initiated by the user.

29. The system of claim 1, wherein the system processor is further configured to provide the profile information of another user of the system based upon search queries initiated by the user and criteria associated with the another user's profile.

30. The system of claim 1, wherein the entity is a business.

31. The system of claim 1, wherein the experience relates to a commercial transaction.

32. A system for disseminating information about a user's commercial experiences with a business comprising:
a processor for communication with a system computer via a system network; and
a memory;
the processor configured to:
store a data structure in the memory, the data structure comprising a profile of the business; and
associate the data structure comprising the business profile with a video representative of the commercial experience of the user interacting with the business when the video is posted to the system network via a local network associated with the business.

33. The system of claim 32, wherein the data structure comprising the profile of the business comprises programming data to enable the execution of instructions to post the video to a home page associated with the business.

34. The system of claim 32, wherein the data structure comprising the profile of the business comprises at least one of a business name, business location, business contact information, business hours, business website, business genre, product name, business rating, product rating, and a number of users favorably associated with the business.

35. A method for disseminating information about a user's experience with an entity:
storing a data structure in a memory, the data structure comprising a plurality of data items representative of a profile of the user, a profile of the entity and a video representative of the experience of the user with the entity;
receiving video data from at least one of a plurality of remote computers, the video data being representative of the user's experience with the entity;
associating the video data with the profile of the user and the profile of the entity to generate the data structure; and
providing experience data to a plurality of remote computers via a network in accordance with criteria associated with the user profile and the entity profile, the provided data pertaining to the user profile, the entity profile, and the video data representative of the experience of the user with the entity;
wherein the method steps are performed by a system processor, the system processor being in communication with the plurality of remote computers via the network and the memory.
